(19) United States
(12) Patent Application Publication
(10) Pub. No.: US 2013/0110592 A1
(43) Pub. Date: May 2, 2013

(54) Computer system

(71) Applicant: Vijay Garg, Plano, TX (US)

(72) Inventor: Vijay Garg, Plano, TX (US)

(21) Appl. No.: 13/317,713

(22) Filed: Oct. 26, 2011

(51) Int. Cl. G06Q 30/02

(52) U.S. Cl. 705/14.1

(57) ABSTRACT

A computer system for discount shifting includes a network server including a microprocessor, a memory and computer software, wherein the computer software is located in the memory and run by the microprocessor, the computer software including a database and an algorithm, wherein the algorithm includes the steps of: writing to the memory an acceptance of an offer from a seller having a retail value when the offer is accepted by a buyer; reading from the memory a buying power of the buyer; recalculating the buying power of the buyer by reducing the buying power of the buyer by an amount equal to the retail value; writing to the memory the reduced buying power of the buyer; transmitting from the network server to the buyer a voucher for the offer from the seller.

### BACKGROUND INFORMATION

1. Field of the Invention

Embodiments of the invention relate generally to the field of computer systems. More particularly, an embodiment of the invention relates to a computer system for implementing a process of consumer (buyer) controlled discount shifting between vendors (sellers).

2. Discussion of the Related Art

Prior art marketing models, sometimes called marketing schemes, are known to those skilled in the art to include advertising and discounts. For instance, a conventional discount coupon is typically provided to a consumer (buyer) in printed, hard-copy form and upon use of that coupon, the consumer receives a discount. Even if the consumer does not use the coupon, it is still an effective advertising vehicle.

A problem with this technology has been consumer dissatisfaction with terms and conditions of the coupon, sometimes called the fine print. Another problem with this technology is that coupons can be lost sometimes.

Meanwhile, it has been known in the field of marketing to offer upgrades at discounted prices to existing customers. It is also known to offer a piece of equipment at cost or below (e.g. Printer) and make a profit on corresponding consumables (e.g. Ink cartridges). Recently, marketing has evolved to include offering a prepaid discount if enough consumers accept (buy).

However, there are doubts that arise in the minds of consumers that act as drawbacks to all prior marketing models. These doubts include fear of poor service, poor quality and lack of repeatability (poor consistency). Instead of mutual suspicion, what is needed is better mutual trust between buyer(s) and seller(s).

### SUMMARY OF THE INVENTION

There is a need for the following embodiments of the invention. Of course, the invention is not limited to these embodiments.

According to an embodiment of the invention, a method of discount shifting, comprising running computer software located in a memory with a microprocessor located in a network server, the computer software including a database and an algorithm for performing the steps of: writing to the memory an acceptance of an offer from a seller having a retail value when the offer is accepted by a buyer; reading from the memory a buying power of the buyer; recalculating the buying power of the buyer by reducing the buying power of the buyer by an amount equal to the retail value; writing to the memory the reduced buying power of the buyer; transmitting from the network server to the buyer a voucher for the offer from the seller; writing to the memory a closure of the offer when the buyer pays a perceived value; reading from the memory the reduced buying power of the buyer; recalculating the buying power of the buyer by restoring the buying power of the buyer by an amount equal to the retail value; writing to the memory the restored buying power of the buyer; when the perceived value is greater than a reasonable value, 1) reading from the memory the buying power of the buyer and a buyer credibility of the buyer, 2) recalculating the buying power of the buyer by increasing the buying power of the buyer and recalculating a buyer credibility of the buyer by increasing the buyer credibility of the buyer, and 3) writing to the memory the increased buying power of the buyer and the increased buyer credibility of the buyer; when the perceived value is equal to the reasonable value, not increasing or decreasing the buying power of the buyer and not increasing or decreasing the buyer credibility of the buyer; when the perceived value is less than the reasonable value, 1) reading from the memory the buying power of the buyer and a buyer credibility of the buyer, 2) recalculating the buying power of the buyer by decreasing the buying power of the buyer and recalculating a buyer credibility of the buyer by decreasing the buyer credibility of the buyer, and 3) writing to the memory the decreased buying power of the buyer and the decreased buyer credibility of the buyer.

According to another embodiment of the invention, a computer system for discount shifting includes a network server including a microprocessor, a memory and computer software, wherein the computer software is located in the memory and run by the microprocessor, the computer software including a database and an algorithm, wherein the algorithm includes the steps of: writing to the memory an acceptance of an offer from a seller having a retail value when the offer is accepted by a buyer; reading from the memory a buying power of the buyer; recalculating the buying power of the buyer by reducing the buying power of the buyer by an amount equal to the retail value; writing to the memory the reduced buying power of the buyer; transmitting from the network server to the buyer a voucher for the offer from the seller; writing to the memory a closure of the offer when the buyer pays the seller a perceived value; reading from the memory the reduced buying power of the buyer; recalculating the buying power of the buyer by restoring the buying power of the buyer by an amount equal to the retail value; writing to the memory the restored buying power of the buyer; when the perceived value is greater than a reasonable value, 1) reading from the memory the buying power of the buyer and a buyer credibility of the buyer, 2) recalculating the buying power of the buyer by increasing the buying power of the buyer and recalculating a buyer credibility of the buyer by increasing the buyer credibility of the buyer, and 3) writing to the memory the increased buying power of the buyer and the increased buyer credibility of the buyer; when the perceived value is equal to the reasonable value, not increasing or decreasing the buying power of the buyer and not increasing or decreasing the buyer credibility of the buyer; when the perceived value is less than the reasonable value, 1) reading from the memory the buying power of the buyer and a buyer credibility of the buyer, 2) recalculating the buying power of the buyer by decreasing the buying power of the buyer and recalculating a buyer credibility of the buyer by decreasing the buyer credibility of the buyer, and 3) writing to the memory the decreased buying power of the buyer and the decreased buyer credibility of the buyer.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 is a schematic block diagram of a computer system for implementing a process of consumer controlled discount shifting between vendors, representing an embodiment of the invention.

FIG. 2 is a schematic block diagram of an architecture for implementing a process of consumer controlled discount shifting between vendors, representing an embodiment of the invention.

FIG. 3 is a flow diagram of a process of consumer controlled discount shifting between vendors that is implemented by a computer program, representing an embodiment of the invention.

FIG. 4 is a flow diagram of a process of defining and adjusting reasonable value that is implemented by a computer program, representing an embodiment of the invention.

FIG. 5 is a flow diagram of a first example of a process of updating buyer credibility and buying power that is implemented by a computer program, representing an embodiment of the invention.

FIG. 6 is a flow diagram of a second example of a process of updating buyer credibility and buying power that is implemented by a computer program, representing an embodiment of the invention.

FIG. 7 is a flow diagram of a third example of a process of updating buyer credibility and buying power that is implemented by a computer program, representing an embodiment of the invention.

FIG. 8 is block schematic view of database fields for buyers and sellers, representing an embodiment of the invention.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The below-referenced U.S. patent(s) and/or U.S. patent application(s) disclose embodiments that are useful for the purposes for which they are intended. The entire contents of U.S. Ser. No. 12/776,028, filed May 10, 2010 (U.S. Pat. App. Pub. 2010/0287103, published Nov. 11, 2010) is(are) hereby expressly incorporated by reference herein for all purposes.

In general, the context of embodiments of the invention can include internet advertising that includes discounts by vendors (sellers) for consumers (buyers). Empowering consumers to express satisfaction, or the lack thereof, in terms of money by shifting their discounts between vendors (sellers) has the significant advantage of improving mutual trust between sellers and buyers. More specifically, the context of embodiments of the invention can include an internet advertising platform for implementing of consumer (buyer) controlled discount shifting between vendors (sellers). This enables a buyer to punish perceived bad sellers and reward perceived good sellers. In this way, embodiments of the invention can be like karma. If historical shifting is visible to all, or at least some, of the prospective buyers, it enables those prospective buyers to base their purchase decision on what others have monetarily punished or rewarded in the past as a result of actual transactions. These are improvements that go beyond reviews. While reviews can be helpful to prospective buyers, viewing the monetary repercussions of historical, real transactions fundamentally improves mutual trust between prospective buyers and rewarded (good) sellers. Discount shifting from real transactions has more veracity to prospective buyers than reviews because reviews can be bias or even faked; and some buyers do not give credence to reviews. From a machine perspective, this means that the context of an embodiment of the invention can comprise an internet advertising platform that includes a plurality of vendor devices, a plurality of consumer devices, the internet, a clearing house database and a discount shifting (web or network) server.

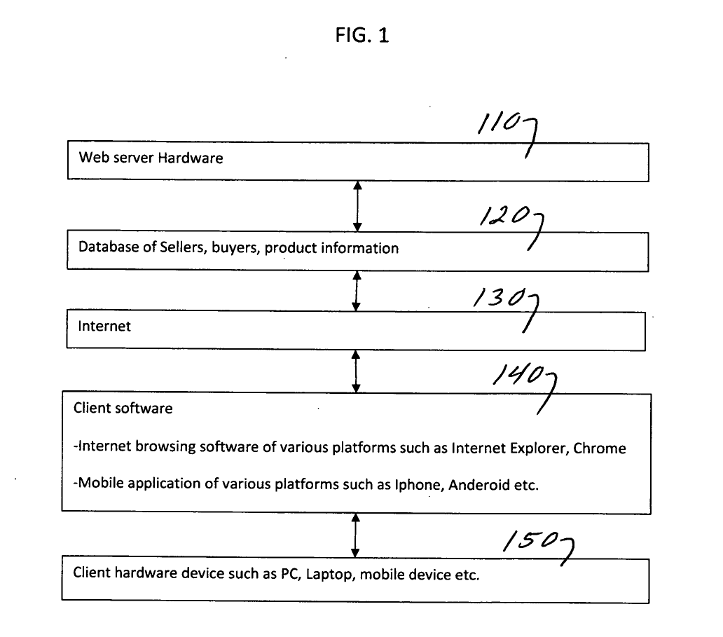

Referring to FIG. 1, an embodiment of the invention can include web server hardware 110. The web server hardware 110 interfaces with one or more database(s) of sellers, buyers and product information 120. The database(s) of sellers, buyers and product information 120 interfaces with the internet 130. The internet interfaces with client software 140. The client software 140 can include internet browsing software of various platforms such as Internet Explorer, Chrome, and et cetera. The client software 140 can include mobile applications of various platforms such as Iphone, Android, et cetera. The client software interfaces with client hardware 150, such as personal computers, laptops, notepads, mobile devices, et cetera.

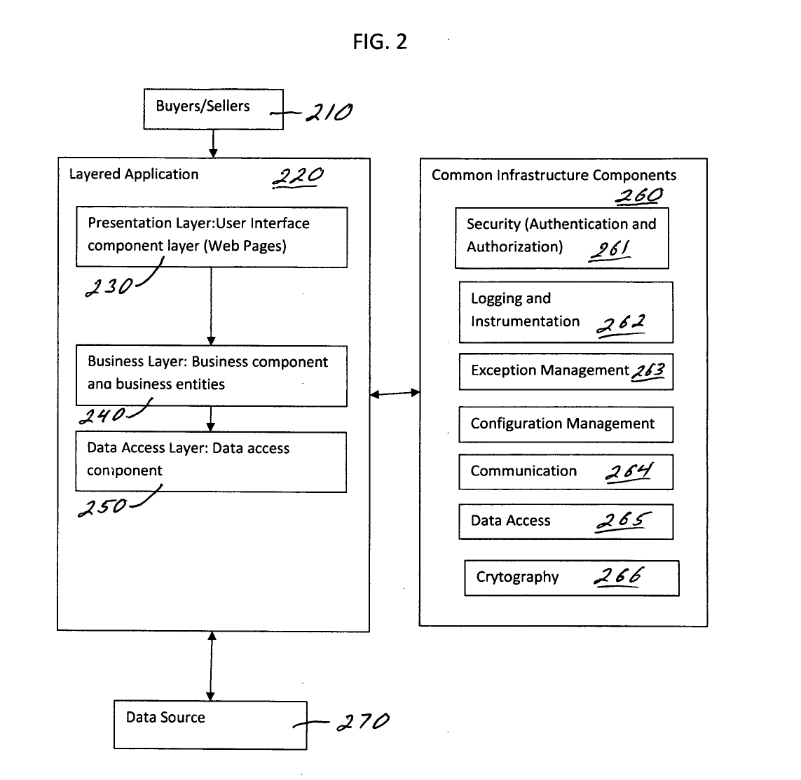

Referring to FIG. 2, an embodiment of the invention can include buyers/sellers 210 that interface with layered application 220. The layered application 220 can include a presentation layer 230.

The layered application 220 can include a business layer 240. The layered application 220 can include a data access layer 230. The layered application interfaces with data source block 270.

Still referring to FIG. 2, the layered application 220 interfaces with common infrastructure components 260. The common infrastructure components 260 can include security 261, logging and instrumentation 262, exception management 263, configuration management, communication 264, data access 265 and cryptography 266.

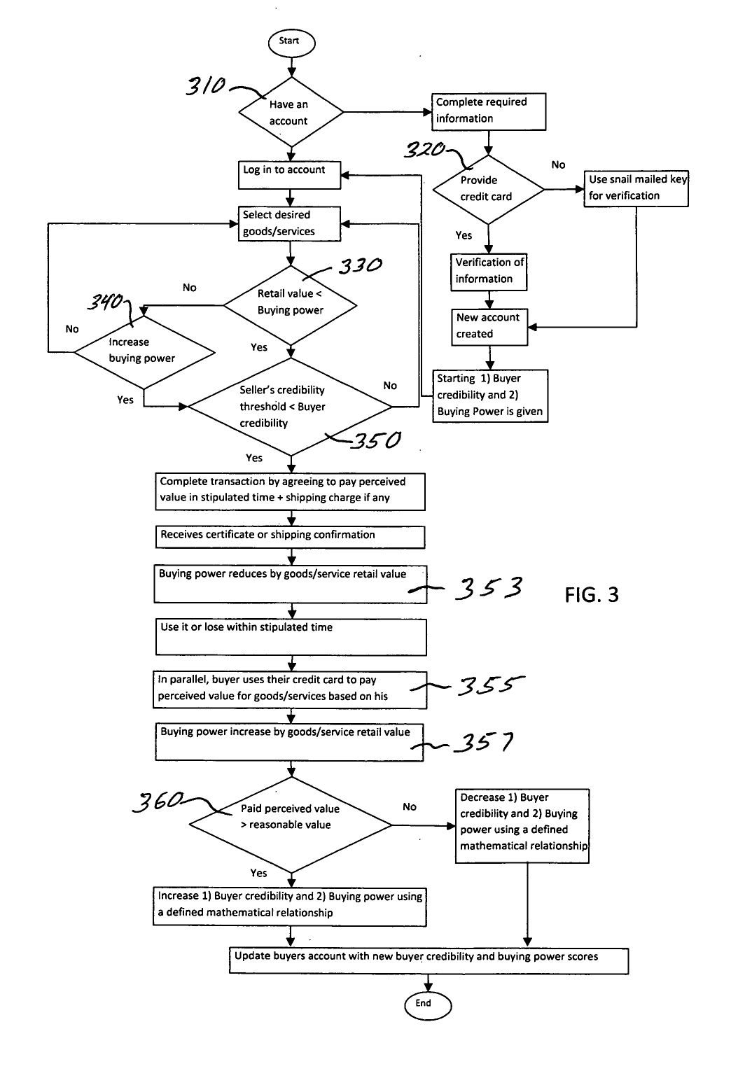

Referring to FIG. 3, an embodiment of the invention can include a front end that begins with an assessment 310 whether a prospective buyer has an existing account. For those prospective buyer who do not have already had an account, a new account can be opened with or without 320 a credit card.

Still referring to FIG. 3, once a prospective buyer has an account an assessment 330 of whether the retail value of an item is less than that buyer's buying power. If the buyer's buying power is not greater than or equal to the retail value of the item, the buyer makes a decision 340 of whether to increase their buying power. If the buyer increases their buying power, they can proceed; if not, the buyer can go back to selecting. If the retail value of the item is less than the buyer's buying power, an assessment 350 of whether the seller's credibility threshold is less than the buyer's buyer credibility is made. If the seller's credibility threshold is less than the buyer's buyer credibility, the buyer can proceed; if not, the buyer can go back to selecting. Completing the transaction, receiving the discount, reducing the buyer's buying power by the goods/services retail value 353 and meeting deadline(s) for use of the discount are part of this embodiment.

Still referring to FIG. 3, in parallel the buyer uses their credit card (or other form of payment) to pay 355 a perceived value for the item (goods/services) based on their satisfaction. It is important to understand that the buyer uses their credit card (or other form of payment) to pay 355 a perceived value for the item (goods/services) based on their satisfaction. Thus, the transaction is paid for independently. The buyer can pay the seller, or the buyer can pay a clearing house, brokerage or middleman. Thus, the buyer's buying power can be adjusted independently of the actual transfer of funds for the transaction. Similarly, the buyer's buyer credibility can be adjusted independently of the transfer of funds for the transaction.

Still referring to FIG. 3, the buying power of the buyer is increased by the good/services retail value 357. This reverses the earlier reducing of the buyer's buying power by the goods/services retail value at 353 in accord with the actual transfer of funds for the transaction done at block 355 in parallel. An assessment 360 is then made of whether to paid perceived value was greater than a reasonable value. The result of this assessment will determine how the buyer's buying power and the buyer's buyer credibility are adjusted. Finally, the buyer's account is updated with new buyer credibility and new buying power scores.

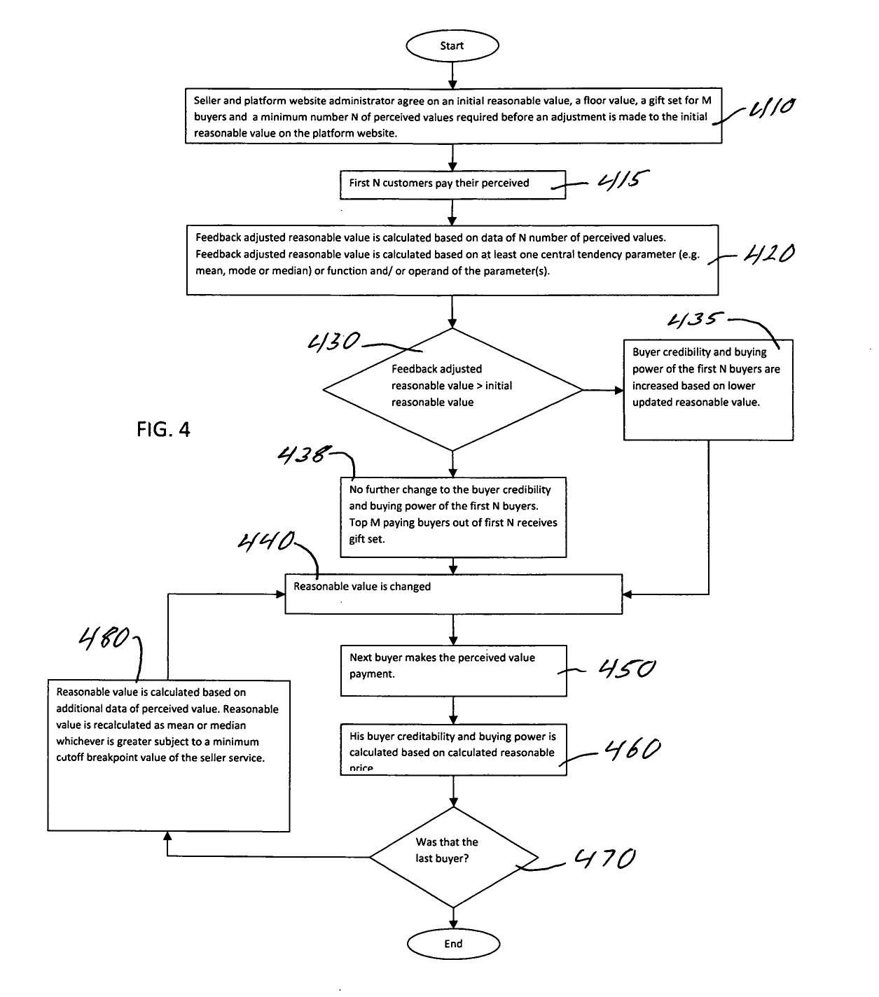

Referring now to FIG. 4, adjustment of the buyer's buying power and the buyer's buyer credibility will now be described in more detail. At 410 the seller and platform website administrator agree on an initial reasonable value, a floor value, (optionally a gift set or other premium for M buyers) and a minimum number N of perceived values required before an adjustment is made to the initial reasonable value on the platform website. At 415 the first N customers (buyers) pay their perceived values. At 420 a feedback adjusted reasonable value is calculated based on data of N number of perceived values. The feedback adjusted reasonable value is calculated based on at least one central tendency parameter (e.g. mean, mode or median) or function and/or operand of the parameter(s). At 430 as assessment is made of whether the feedback adjusted reasonable value is greater than the initial reasonable value. If yes, at 438 no further change to the buyer credibility and buying power of the first N buyers (optionally the top M paying buyers out of first N could receive a gift set or other premium). If no, at 435 the buyer credibility and buying power of the first N buyers are increased based on the lower updated reasonable value. Either way, the reasonable value is changed at 440.

Still referring to FIG. 4, at 450, a next buyer makes their perceived value payment. At 460, that next buyer's buyer credibility and buying power is calculated (adjusted) based on current calculated reasonable value (price). At 470, it is determined whether that next buyer was the last buyer. If not, (i.e. the offer remained open and another buyer subsequently completed their transaction), then at 480 the reasonable value is re-calculated based on additional data of perceived value by that next buyer. To clarify terminology, the “subsequent buyer” comes along after the “next buyer.” In preferred embodiments, the reasonable value is recalculated at 480 as mean or median whichever is greater subject to a minimum cutoff breakpoint value of the seller service.

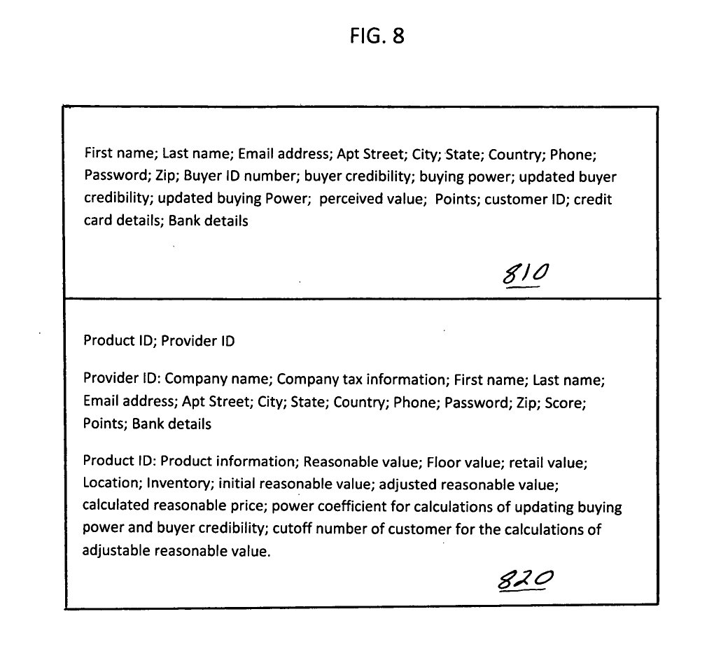

Referring to FIG. 8, an embodiment of the invention can include database fields for buyers and sellers. Database fields for buyers 810 can includes: First name; Last name; Email address; Apt Street; City; State; Country; Phone; Password; Zip; Buyer ID number; buyer credibility; buying power; updated buyer credibility; updated buying Power; perceived value; Points; customer ID; credit card details; Bank details.

Still referring to FIG. 8, database fields for sellers 820 can include: Product ID; Provider ID. The Provider ID field can include: Company name; Company tax information; First name; Last name; Email address; Apt Street; City; State; Country; Phone; Password; Zip; Score; Points; Bank details. The Product ID field can include: Product information; Reasonable value; Floor value; retail value; Location; Inventory; initial reasonable value; adjusted reasonable value; calculated reasonable price; power coefficient for calculations of updating buying power and buyer credibility; cutoff number of customer for the calculations of adjustable reasonable value. Of course, these buyer and seller fields are just examples and embodiments of the invention can include fewer and/or other database fields.

### EXAMPLES

Specific embodiments of the invention will now be further described by the following, nonlimiting examples which will serve to illustrate in some detail various features. The following examples are included to facilitate an understanding of ways in which an embodiment of the invention may be practiced. It should be appreciated that the examples which follow represent embodiments discovered to function well in the practice of the invention, and thus can be considered to constitute preferred mode(s) for the practice of the embodiments of the invention. However, it should be appreciated that many changes can be made in the exemplary embodiments which are disclosed while still obtaining like or similar result without departing from the spirit and scope of an embodiment of the invention. Accordingly, the examples should not be construed as limiting the scope of the invention.

### Example 1

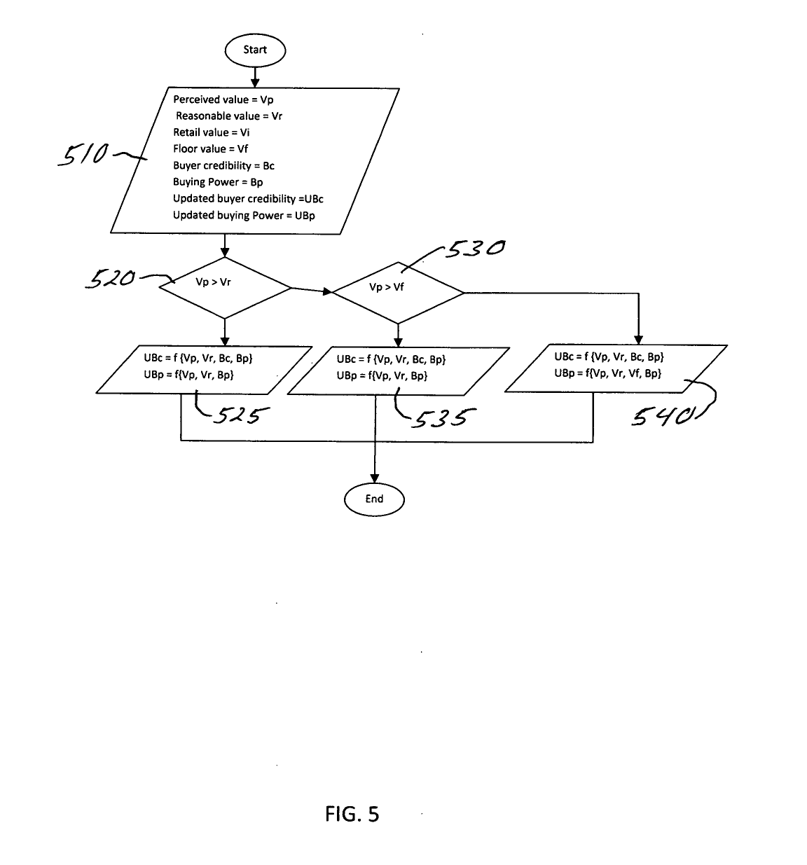

Referring to FIG. 5, a first example of update buyer credibility and buying power is illustrated. In this example, the variables 510 involved are subject to decisions 520 and 530 and updated at blocks 525, 535, 540.

### Example 2

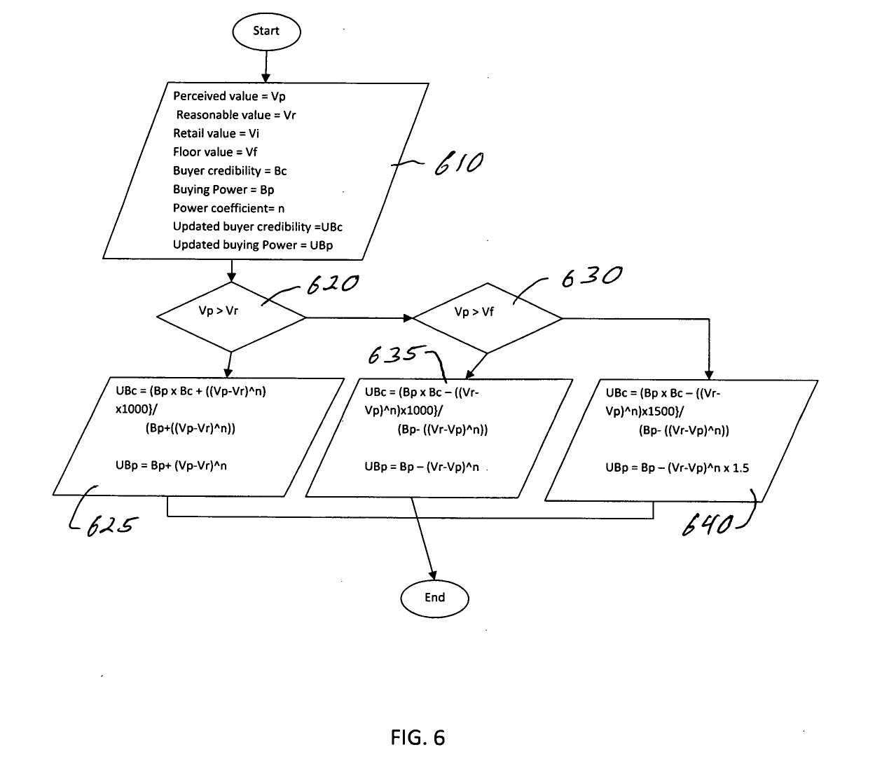

Referring to FIG. 6, a second example of update buyer credibility and buying power is illustrated. In this example, the variables 610 involved are subject to decisions 620 and 630 and updated at blocks 625, 635, 640.

### Example 3

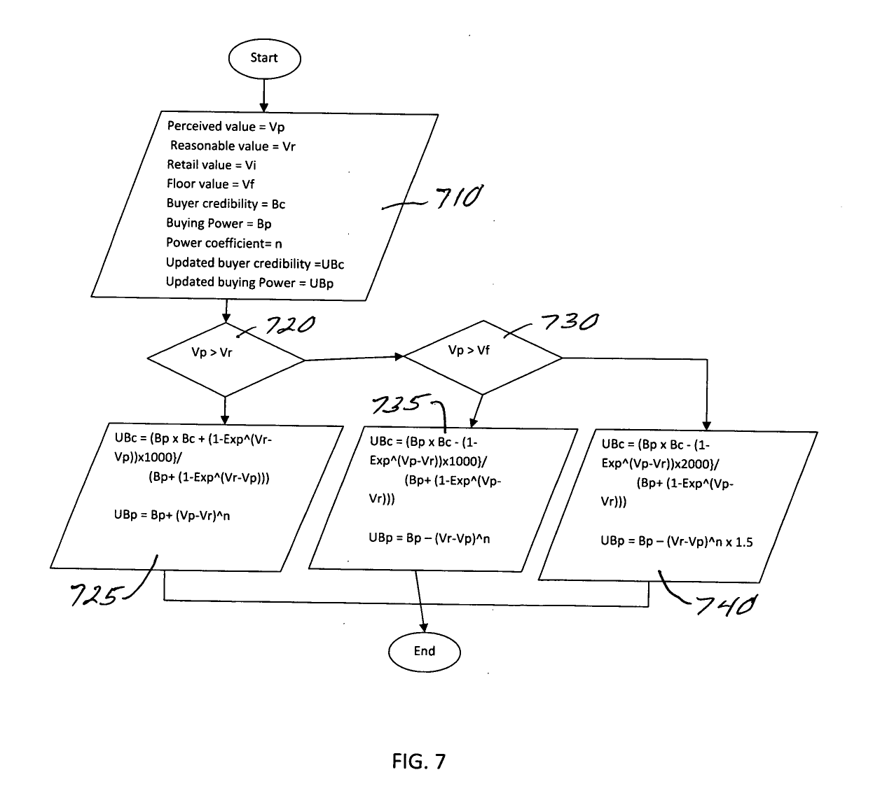

Referring to FIG. 7, a third example of update buyer credibility and buying power is illustrated. In this example, the variables 710 involved are subject to decisions 720 and 730 and updated at blocks 725, 735, 740.

### Definitions

The phrase retail value is intended to mean the full asking price for goods and/or services. The phrase perceived value is intended to mean what a buyer chooses to pay for goods and/or services after receipt and/or experience of those goods and/or services. The phrase reasonable value is intended to mean fixed and/or variable costs plus a comparable risk alternative rate of return. The phrase buyer power is intended to mean the caliber or apparent energy available to a buyer for deployment by the software. The phrase buyer credibility is intended to mean the stroke or reach available to a buyer for deployment by the software. The phrase social media platform is intended to mean web-based and mobile technologies that turn communication into interactive dialogue, such as a communication forum where you can leave comment and connect with people (e.g., Twitter and/or Facebook). The terms program and/or software and/or the phrases computer program and/or computer software are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this invention belongs. In case of conflict, the present specification, including definitions, will control.

### Conclusion

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be combined in the disclosed configurations, but could be combined in any and all configurations.

Various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method of discount shifting, comprising running computer software located in a memory with a microprocessor located in a network server, the computer software including a database and an algorithm for performing the steps of:
writing to the memory an acceptance of an offer from a seller having a retail value when the offer is accepted by a buyer;
reading from the memory a buying power of the buyer;
recalculating the buying power of the buyer by reducing the buying power of the buyer by an amount equal to the retail value;
writing to the memory the reduced buying power of the buyer;
transmitting from the network server to the buyer a voucher for the offer from the seller;
writing to the memory a closure of the offer when the buyer pays a perceived value;
reading from the memory the reduced buying power of the buyer;
recalculating the buying power of the buyer by restoring the buying power of the buyer by an amount equal to the retail value;
writing to the memory the restored buying power of the buyer;
when the perceived value is greater than a reasonable value, 1) reading from the memory the buying power of the buyer and a buyer credibility of the buyer, 2) recalculating the buying power of the buyer by increasing the buying power of the buyer and recalculating a buyer credibility of the buyer by increasing the buyer credibility of the buyer, and 3) writing to the memory the increased buying power of the buyer and the increased buyer credibility of the buyer;
when the perceived value is equal to the reasonable value, not increasing or decreasing the buying power of the buyer and not increasing or decreasing the buyer credibility of the buyer;
when the perceived value is less than the reasonable value, 1) reading from the memory the buying power of the buyer and a buyer credibility of the buyer, 2) recalculating the buying power of the buyer by decreasing the buying power of the buyer and recalculating a buyer credibility of the buyer by decreasing the buyer credibility of the buyer, and 3) writing to the memory the decreased buying power of the buyer and the decreased buyer credibility of the buyer.

2. The method of claim 1, wherein the buyer credibility is greater than zero before writing to the memory the acceptance of the offer.

3. The method of claim 2, wherein the buyer credibility of the buyer is greater than or equal to a credibility threshold associated with the offer before writing to the memory the acceptance of the offer.

4. The method of claim 3, wherein the buying power of the buyer is greater than or equal to a retail price associated with the offer before writing to the memory the acceptance of the offer before writing to the memory the closure.

5. The method of claim 4, wherein before writing to the memory the closure, the buyer pays the perceived value to the seller; and the seller then pays a commission to a clearing house deploying the computer software.

6. The method of claim 5, further comprising the seller uploading a review of the seller on a social media platform.

7. The method of claim 5, further comprising the seller uploading a review of the clearing house that deploys the computer software on a social media platform.

8. The method of claim 4, wherein before writing to the memory the closure, the buyer pays the perceived value to a clearing house deploying the computer software; and the clearing house then pays the seller the perceived value minus a commission.

9. The method of claim 8, further comprising the buyer uploading a review of the seller on a social media platform.

10. The method of claim 8, further comprising the buyer uploading a review of the clearing house that deploys the computer software on a social media platform.

11. The method of claim 1, wherein the buyer credibility of the buyer is greater than or equal to a credibility threshold associated with the offer before writing to the memory the acceptance of the offer.

12. The method of claim 1, wherein the buying power of the buyer is greater than or equal to a retail price associated with the offer before writing to the memory the acceptance of the offer before writing to the memory the closure.

13. The method of claim 1, wherein before writing to the memory the closure, the buyer pays the perceived value to the seller; and the seller then pays a commission to a clearing house deploying the computer software.

14. The method of claim 1, further comprising the buyer uploading a review of the seller on a social media platform.

15. The method of claim 1, further comprising the buyer uploading a review of the clearing house that deploys the computer software on a social media platform.

16. The method of claim 1, wherein before writing to the memory the closure, the buyer pays the perceived value to a clearing house deploying the computer software; and the clearing house then pays the seller the perceived value minus a commission.

17. A machine readable medium, comprising a computer program for performing the method of claim 1.

18. An apparatus, comprising the machine readable medium of claim 17.

19. A computer system for discount shifting, comprising a network server including a microprocessor, a memory and computer software, wherein the computer software is located in the memory and run by the microprocessor, the computer software including a database and an algorithm, wherein the algorithm includes the steps of:
writing to the memory an acceptance of an offer from a seller having a retail value when the offer is accepted by a buyer;
reading from the memory a buying power of the buyer;
recalculating the buying power of the buyer by reducing the buying power of the buyer by an amount equal to the retail value;
writing to the memory the reduced buying power of the buyer;
transmitting from the network server to the buyer a voucher for the offer from the seller;
writing to the memory a closure of the offer when the buyer pays the seller a perceived value;
reading from the memory the reduced buying power of the buyer;
recalculating the buying power of the buyer by restoring the buying power of the buyer by an amount equal to the retail value;
writing to the memory the restored buying power of the buyer;
when the perceived value is greater than a reasonable value, 1) reading from the memory the buying power of the buyer and a buyer credibility of the buyer, 2) recalculating the buying power of the buyer by increasing the buying power of the buyer and recalculating a buyer credibility of the buyer by increasing the buyer credibility of the buyer, and 3) writing to the memory the increased buying power of the buyer and the increased buyer credibility of the buyer;
when the perceived value is equal to the reasonable value, not increasing or decreasing the buying power of the buyer and not increasing or decreasing the buyer credibility of the buyer;
when the perceived value is less than the reasonable value, 1) reading from the memory the buying power of the buyer and a buyer credibility of the buyer, 2) recalculating the buying power of the buyer by decreasing the buying power of the buyer and recalculating a buyer credibility of the buyer by decreasing the buyer credibility of the buyer, and 3) writing to the memory the decreased buying power of the buyer and the decreased buyer credibility of the buyer.

20. The computer system of claim 21, further comprising a payment server coupled to the network server, wherein the buyer pays the seller the perceived value using the payment server and the payment server transmits the closure of the offer to the network server.

21. A method of discount shifting, comprising running computer software located in a memory with a microprocessor located in a network server, the computer software including a database and an algorithm for performing the steps of:
writing to the memory an acceptance of an offer from a seller having a retail value when the offer is accepted by a buyer;
reading from the memory a buying power of the buyer;
recalculating the buying power of the buyer by reducing the buying power of the buyer by an amount equal to the retail value;
writing to the memory the reduced buying power of the buyer;
transmitting from the network server to the buyer a voucher for the offer from the seller;
writing to the memory a closure of the offer when the buyer pays a perceived value;
reading from the memory the reduced buying power of the buyer;
recalculating the buying power of the buyer by restoring the buying power of the buyer by an amount equal to the retail value;
writing to the memory the restored buying power of the buyer;
when the perceived value is greater than a reasonable value, 1) reading from the memory the buying power of the buyer, 2) recalculating the buying power of the buyer by increasing the buying power of the buyer, and 3) writing to the memory the increased buying power of the buyer;
when the perceived value is equal to the reasonable value, not increasing or decreasing the buying power of the buyer;
when the perceived value is less than the reasonable value, 1) reading from the memory the buying power of the buyer, 2) recalculating the buying power of the buyer by decreasing the buying power of the buyer, and 3) writing to the memory the decreased buying power of the buyer.
